(19) United States
(12) Patent Application Publication
(10) Pub. No.: US 2026/0006637 A1
(43) Pub. Date: Jan. 1, 2026

(54) SYSTEMS AND METHODS FOR OPTIMIZED ENERGY DETECT THRESHOLDS FOR DEVICES

(71) Applicant: Meta Platforms Technologies, LLC, Menlo Park, CA (US)

(72) Inventors: Carlos Horacio Aldana, Mountain View, CA (US); Davide Magrin, Milan (IT); Muhammad Kumail Haider, Sunnyvale, CA (US); Guoqing Li, Cupertino, CA (US); Kanji Mavji Kerai, London (GB)

(73) Assignee: Meta Platforms Technologies, LLC, Menlo Park, CA (US)

(21) Appl. No.: 19/235,261

(22) Filed: Jun. 11, 2025

Related U.S. Application Data
(60) Provisional application No. 63/665,129, filed on Jun. 27, 2024.

(51) Int. Cl. H04W 74/0808; H04W 16/14; H04W 84/12

(52) U.S. Cl. CPC H04W 74/0808; H04W 16/14; H04W 84/12

(57) ABSTRACT

Systems and methods for optimized energy detection thresholds may include a first device which determines an instantaneous transmission power for a packet to be transmitted by the first device to a second device via a narrowband (NB) communication link. The first device may determine an energy detection threshold (EDT), as a function of the instantaneous transmission power for the packet and a defined value. The first device may transmit, to the second device, the packet according to the EDT via the NB communication link.

### CROSS-REFERENCE TO RELATED APPLICATION

This application claims the benefit of and priority to U.S. Provisional Application No. 63/665,129, filed Jun. 27, 2024, the contents of which are incorporated by reference in its entirety.

### FIELD OF DISCLOSURE

The present disclosure is generally related to communication between wireless devices, including but not limited to, systems and methods for optimized energy detection thresholds for devices, such as narrowband (NB) devices, operating in 5 gigahertz (GHz) and 6 GHz frequencies.

### BACKGROUND

Wireless communication systems may use energy detection thresholds (EDT) to manage channel access. Some EDT methods may be suboptimal for certain device types, which can lead to reduced transmission opportunities and/or increased interference.

### SUMMARY

In one aspect, this disclosure relates to a method including determining, by a first device, an instantaneous transmission power for a packet to be transmitted by the first device to a second device via a narrowband (NB) communication link. The method may include determining, by the first device, an energy detection threshold (EDT), as a function of the instantaneous transmission power for the packet and a defined value. The method may include transmitting, by the first device to the second device, the packet according to the EDT via the NB communication link.

In some embodiments, determining the EDT as a function of the instantaneous transmission power and the defined value includes determining the EDT by reducing the defined value by the instantaneous transmission power. In some embodiments, the method further includes determining, by the first device, that a maximum transmission power is less than, or less than or equal to, a threshold transmission power. The first device may determine the EDT as a function of the instantaneous transmission power and the defined value responsive to the maximum transmission power being less than, or less than or equal to the threshold transmission power. In some embodiments, the threshold transmission power is 14 dBm. In some embodiments, the method further includes determining, by the first device, the defined value to be used to determine the EDT, based at least on a frequency band corresponding to the NB communication link.

In some embodiments, the method further includes determining, by the first device, the defined value to be used to determine the EDT, based at least on a presence of one or more third devices in an environment, including the first device and the second device, which operate on a wireless local area network (WLAN) communication link in the environment. In some embodiments, the method further includes receiving, by the first device, an advertising signal indicating the presence of the one or more third devices operating on the WLAN communication link. In some embodiments, the defined value is a numerical value within a range between −65 decibels relative to one milliwatt per megahertz dBm/MHz and −85 dBm/MHz.

In some embodiments, the method further includes detecting, by the first device, a reception (RX) energy on the NB communication link which is greater than the EDT threshold. The method may further include reducing, by the first device, the instantaneous transmission power for the packet to be transmitted to the second device, based on the RX energy being greater than the EDT threshold. Transmitting the packet according to the EDT may be performed based on the reduction of the instantaneous transmission power. In some embodiments, the method further includes determining, by the first device, that an attempt to transmit the packet is a last retry attempt. Reducing the instantaneous transmission power for the packet may be performed based on the attempt being a last retry attempt.

In another aspect, this disclosure relates to a first device including a wireless transceiver configured to operate on narrowband (NB) communication links, and one or more processors configured to determine an instantaneous transmission power for a packet to be transmitted by the first device to a second device via a narrowband (NB) communication link. The one or more processors may be configured to determine an energy detection threshold (EDT), as a function of the instantaneous transmission power for the packet and a defined value. The one or more processors may be configured to transmit, via the wireless transceiver to the second device, the packet according to the EDT via the NB communication link.

In some embodiments, the one or more processors are configured to determine the EDT by reducing the defined value by the instantaneous transmission power. In some embodiments, the one or more processors are configured to determine that a maximum transmission power is less than, or less than or equal to, a threshold transmission power of 14 dBm. The one or more processors may determine the EDT as a function of the instantaneous transmission power and the defined value responsive to the maximum transmission power being less than, or less than or equal to the threshold transmission power. In some embodiments, the one or more processors are configured to determine the defined value to be used to determine the EDT, based at least on a frequency band corresponding to the NB communication link.

In some embodiments, the one or more processors are configured to determine the defined value to be used to determine the EDT, based at least on a presence of one or more third devices in an environment, including the first device and the second device, which operate on a wireless local area network (WLAN) communication link in the environment. In some embodiments, the one or more processors are configured to receive, via the wireless transceiver, an advertising signal indicating the presence of the one or more third devices operating on the WLAN communication link. In some embodiments, the defined value is a numerical value within a range between −65 decibels relative to one milliwatt per megahertz dBm/MHz and −85 dBm/MHz.

In some embodiments, the one or more processors are configured to detect a reception (RX) energy on the NB communication link which is greater than the EDT threshold, and reduce the instantaneous transmission power for the packet to be transmitted to the second device, based on the RX energy being greater than the EDT threshold. The one or more processors may transmit the packet according to the EDT based on the reduction of the instantaneous transmission power. In some embodiments, the one or more processors are configured to determine that an attempt to transmit the packet is a last retry attempt. The one or more processors may reduce the instantaneous transmission power for the packet based on the attempt being a last retry attempt.

In yet another aspect, this disclosure relates to a non-transitory computer readable medium storing instructions that, when executed by one or more processors of a first device, cause the one or more processors to determine an instantaneous transmission power for a packet to be transmitted by the first device to a second device via a narrowband (NB) communication link. The instructions may cause the one or more processors to determine an energy detection threshold (EDT), as a function of the instantaneous transmission power for the packet and a defined value. The instructions may cause the one or more processors to transmit, to the second device, the packet according to the EDT via the NB communication link.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of an environment including a plurality of devices, according to various implementations of the present disclosure.

FIG. 5 is a block diagram of a system for determining and optimizing EDTs, according to an example implementation of the present disclosure.

FIG. 6A-FIG. 14C are graphs showing simulations relating to various operating scenarios involving narrowband (NB) and WLAN devices sharing common frequency bands, according to example implementations of the present disclosure.

FIG. 15A-15C depicted are graphs showing optimized EDTs for devices operating with a maximum transmission power less than 14 dBm, according to example implementations of the present disclosure.

FIG. 16 is a graph showing optimized EDTs for devices (e.g., 2 megahertz MHz or 4 MHz narrowband devices) operating with a maximum transmission power less than 14 dBm, according to example implementations of the present disclosure.

FIG. 17 is a flowchart showing an example method of configuring an energy detection threshold, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

This disclosure relates to systems and methods for optimal/optimized energy detection thresholds for certain device types, such as narrowband (NB) devices operating in 5 and 6 GHz. The systems and methods described herein may implement dynamic and optimized energy detection thresholds (EDTs) based on various device conditions, network usage conditions, and/or transmission power. For example, the systems and methods described herein may use an estimated/determined instantaneous transmission power for transmitting a particular packet or signal on a frequency channel/band/bandwidth, to dynamically configure/select/determine an EDT, which may provide for lower transmission power with increased transmission opportunities and/or decreased interference.

In some wireless communication systems or solutions, certain devices, such as NB devices, may use 5 and 6 GHz frequency bands for communication. Some solutions may have a fixed EDT of −75 dBm/MHz for all maximum transmission powers less than or equal to 14 dBm. In some implementations in which the fixed EDT is set for maximum transmission powers less than or equal to 14 dBm, such implementations may impact NB devices because such devices may—in some scenarios—only operate with a maximum transmission power which is less than or equal to 14 dBm, but could benefit from dynamic EDTs to improve transmission opportunities without link budget degradation

According various embodiments of the present disclosure, a first device (such as a NB device) may determine an instantaneous transmission power for a packet to be transmitted by the first device to a second device via an NB communication link. The first device may determine an EDT as a function of the instantaneous transmission power for the packet and a defined value. The first device may transmit the packet to the second device, according to the EDT via the NB communication link.

According to the systems and methods described herein, by determining the EDT as a function of the instantaneous transmission power and a defined value, the EDT may be dynamic for NB devices communicating packets via an NB communication link. For instance, instead of using a fixed EDT for NB devices (e.g., NB devices with a maximum transmission power of less than, or less than or equal to 14 dBm), such NB devices may dynamically configure/set/determine the EDT based on the instantaneous transmission power and the defined value, thereby resulting in improved transmission opportunities without link budget degradation. For example, if a NB device were to use a fixed EDT but have a lower instantaneous transmission power, the NB device may delay or forego transmission of a packet, despite a decreased likelihood of causing interference due to the lower instantaneous transmission power, if a detected/identified/determined energy on the NB communication link satisfies the fixed EDT. According to the systems and methods of the present solution, by having a dynamic EDT which is set/determined/identified according to the instantaneous transmission power and the defined value, the NB device may transmit a packet in circumstances/scenarios in which the NB device may have otherwise delayed or foregone transmission of the packet using a fixed EDT.

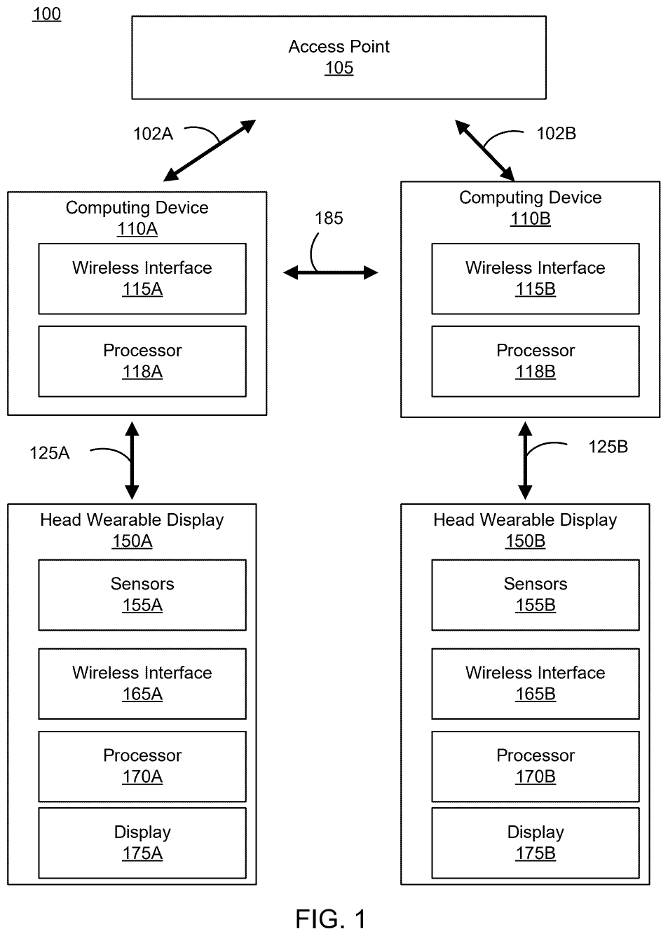

FIG. 1 is a block diagram of an example artificial reality system environment 100. In some embodiments, the artificial reality system environment 100 includes an access point (AP) 105, one or more HWDs 150 (e.g., HWD 150A, 150B), and one or more computing devices 110 (computing devices 110A, 110B; sometimes referred to as consoles) providing data for artificial reality to the one or more HWDs 150. The access point 105 may be a router or any network device allowing one or more computing devices 110 and/or one or more HWDs 150 to access a network (e.g., the Internet). The access point 105 may be replaced by any communication device (cell site). A computing device 110 may be a custom device or a mobile device that can retrieve content from the access point 105, and provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the access point 105 through a wireless link (e.g., interlink). Examples of the wireless link 125 include a near field communication link, Wi-Fi direct, Bluetooth, or any wireless communication link. In some embodiments, the wireless link 125 may include one or more ultra-wideband communication links, as described in greater detail below. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the access point 105 through a wireless link 102 (e.g., interlink). Examples of wireless link 102 include a cellular communication link, a near field communication link, Wi-Fi, Bluetooth, 60 GHz wireless link, ultra-wideband link, or any wireless communication link. The wireless interface 115 may also include a component to communicate with a different computing device 110 through a wireless link 185. Examples of the wireless link 185 include a near field communication link, Wi-Fi direct, Bluetooth, ultra-wideband link, or any wireless communication link. Through the wireless link 102 (e.g., interlink), the wireless interface 115 may obtain AR/VR content, or other content from the access point 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118, 170 may configure or cause the wireless interfaces 115, 165 to toggle, transition, cycle or switch between a sleep mode and a wake up mode. In the wake up mode, the processor 118 may enable the wireless interface 115 and the processor 170 may enable the wireless interface 165, such that the wireless interfaces 115, 165 may exchange data. In the sleep mode, the processor 118 may disable (e.g., implement low power operation in) the wireless interface 115 and the processor 170 may disable the wireless interface 165, such that the wireless interfaces 115, 165 may not consume power or may reduce power consumption. The processors 118, 170 may schedule the wireless interfaces 115, 165 to switch between the sleep mode and the wake up mode periodically every frame time (e.g., 11 ms or 16 ms). For example, the wireless interfaces 115, 165 may operate in the wake up mode for 2 ms of the frame time, and the wireless interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced.

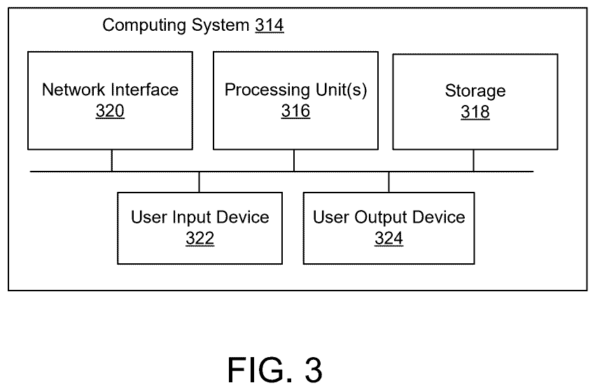

Various operations described herein can be implemented on computer systems. FIG. 3 shows a block diagram of a representative computing system 314 usable to implement the present disclosure. In some embodiments, the computing device 110, the HWD 150, devices 302, 304, or each of the components of FIG. 1-5 are implemented by or may otherwise include one or more components of the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, UWB, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

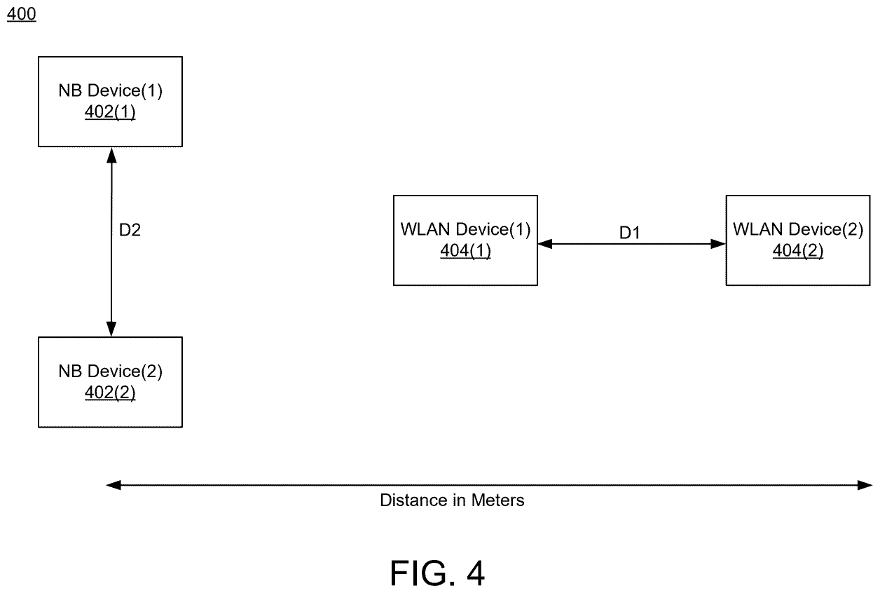

Referring now to FIG. 4, depicted is an environment 400 including a plurality of devices, according to various implementations of the present disclosure. As shown in FIG. 4, the environment 400 may include two or more narrowband (NB) devices 402(1), 402(2), and two or more wireless local area network (WLAN) devices 404(1), 404(2). The NB devices 402 and WLAN devices 404 may be co-located within the environment 400 (e.g., at respective distances D1, D2 from one another). The NB devices 402 may be configured to communicate with one another via respective NB channels/communication links, and the WLAN devices 404 may be configured to communicate with one another via respective WLAN channels/communication links.

The NB devices 402(1), 402(2) may be or include wireless communication devices which communicate using narrowband wireless technology, such as IoT devices, sensors, wearables, smart home appliances, and so forth. The WLAN devices 404(1), 404(2) may be or include wireless communication devices configured to support high-bandwidth WLAN communications, for example devices operating under the IEEE 802.11 wireless networking standards, including WLAN access points, stations, routers, computing equipment, or other suitable wireless LAN equipment. As shown in FIG. 4, WLAN device(1) 404(1) and WLAN device(2) 404(2) may be situated/positioned/located at a distance from one another shown as distance D1, and NB device(1) 402(1) and NB device(2) 402(2) may be situated/positioned/located at a distance from one another shown as distance D2. As the distances D1, D2 change, and as the devices 402, 404 operate on similar frequency bands, communications between such devices 402, 404 may cause changes in interference, signal detection coverage, and coexistence behavior. In various implementations, the NB devices 402(1), 402(2) and WLAN devices 404(1), 404(2) may both operate in shared wireless communication frequency bands, such as the frequency segments of the Unlicensed National Information Infrastructure (UNII) bands-such as UNII-3, UNII-4, UNII-5, or the like. Operation within these frequency bands may lead to interference or coexistence challenges between NB devices 402(1), 402(2) and WLAN devices 404(1), 404(2).

As described in greater detail below, NB devices 402 operating in an environment, such as the environment 400 which includes WLAN devices 404, or a different environment which includes other NB devices 402, may be configured to dynamically configure an energy detection threshold (EDT) for use in transmitting (or delay/foregoing transmission of) packet(s) to other NB devices 402. The NB devices 402 may be configured to determine the EDT based on or according to an instantaneous transmission power to be used for transmitting a packet and a defined value, thereby providing a dynamic EDT which is configured for such NB devices 402 according to operating conditions and environment conditions.

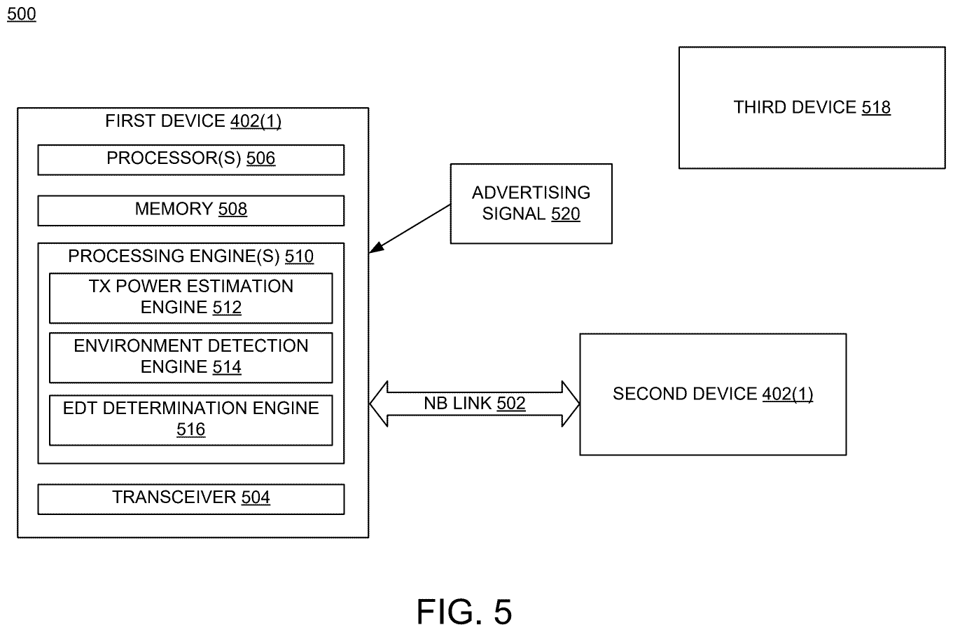

Referring now to FIG. 5, depicted is a block diagram of a system 500 for determining and optimizing EDTs, according to an example implementation of the present disclosure. The system 500 may be implemented in, or may correspond to, the environment 400 illustrated in FIG. 4. For example, the system 500 may include the first NB device(1) 402(1) which is configured to establish a communication link (e.g., a NB communication link 502) with the second NB device 402(2). The system 500 may include one or more third devices 518 (which can be a different NB device and/or a WLAN device 404). In various implementations, the third device(s) 518 may be configured to operate/communicate on a frequency band which is shared with the NB communication link 502, such that, in various instances, the third device 518 may transmit/receive signals which have the potential to interfere with communications on the NB communication link 502. As described in greater detail below, the first device 402(1) may be configured to determine an instantaneous transmission power for a packet to be transmitted by the first device 402(1) to the second device 402(2) via the NB communication link 502. The first device 402(1) may be configured to determine an EDT as a function of the instantaneous transmission power for the packet and a defined value. The first device 402(1) may be configured to transmit the packet to the second device 402(2) according to the EDT via the NB communication link 502.

The first device 402(1) may include a transceiver 504. The transceiver 504 may be the same as or similar to the wireless interface 115, 165 and/or network interface 320 described above with reference to FIG. 1-FIG. 3. In various embodiments, the transceiver 504 may be or include an antenna and related hardware/circuitry configured to operate according to a NB standard or protocol, such as BLUTOOTH.

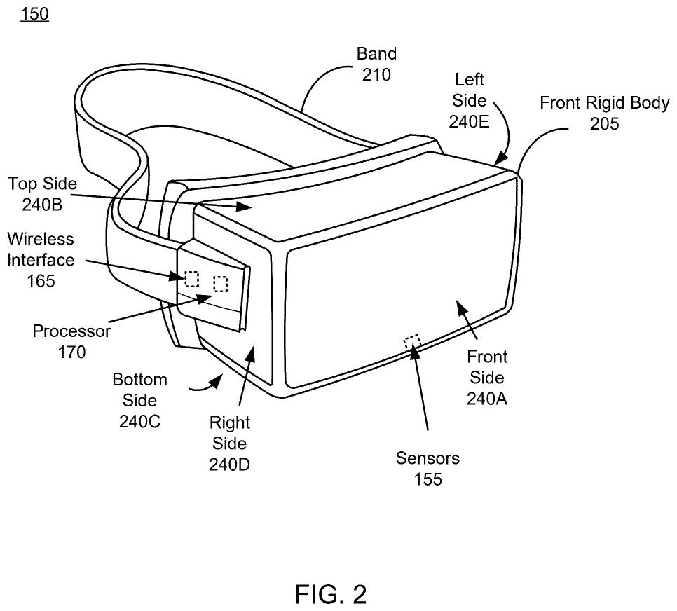

The first device 402(1) may include one or more processors 506. The processor(s) 506 may be similar to the processor(s) 118, 170 described above with reference to FIG. 1 and FIG. 2, and/or the processing unit(s) 316 described above with reference to FIG. 3. The processor(s) 506 may be configured to execute various applications/resources/services (referred to generally as application(s)) of the first device 402(1). The processor(s) 506 may be configured to generate data/packets/data frames responsive to executing the application(s) of the first device 402(1).

The first device 402(1) may include memory 508. The memory 508 may be or include a static random access memory (SRAM), RAM, ROM, Flash memory, hard disk storage, or any other types of memory, storage drive or storage register, internal to the device 402(1), included within an integrated circuit of the device 402(1), etc. The memory 508 may be configured to store data and/or computer code for completing or facilitating the various processes, layers and hardware described herein. The memory 508 may be or include volatile memory or non-volatile memory, and may include database components, object code components, script components, or any other type of information structure for supporting the various activities and information structures described in the present disclosure. According to an example embodiment, the memory is communicably connected to the processor(s) 506 via a processing circuit and includes computer code for executing (e.g., by the processing circuit and/or the processor(s) 506) various applications, functions, software, and so forth. The first device 402(1) may include one or more processing engines 510. The processing engine(s) 510 may be or include any device, component, element, or hardware designed or configured to execute, implement, or otherwise perform one or more functions described herein. In some embodiments, the processing engine(s) 510 may include the processor(s) 506 which execute instruction(s) from memory 508 to perform corresponding functions described herein. The processing engine(s) 510 may include a transmission power estimation engine 512, an environment detection engine 514, and an EDT determination engine 516. While these processing engine(s) 510 are shown and described, in various embodiments, alternative, additional, and/or fewer processing engine(s) 510 may be implemented in the systems described herein. For example, and in some embodiments, a processing engine 510 may be divided into/distributed across multiple processing engines. As another example, and in some embodiments, two or more processing engines 510 may be combined to form a single processing engine 510.

While described above with reference to the first device 402(1), in various implementations, the second device 402(2) may include similar hardware/components/elements as shown in the first device 402(1). For example, the second device 402(2) may similarly include a transceiver, processor(s), memory, and processing engine(s).

The first device 402(1) may include a transmission power estimation engine 512. The transmission power estimation engine 512 may be configured to detect, identify, estimate, or otherwise determine an instantaneous transmission power of packets to be transmitted to another device (e.g., second NB device 402(2)) via the narrowband (NB) communication link 502. The instantaneous transmission power may be a transmission power which is to be used (or is determined to be used) for transmitting a particular packet, which is less than, or less than or equal to, a defined maximum transmission power for the transceiver 504. The defined maximum transmission power may be, for example, an upper limit of 14 dBm, or another relevant defined threshold value. The transmission power estimation engine 512 may be configured to determine the instantaneous transmission power based on transmission parameters associated with the packet and/or based on channel metrics/conditions, as described in greater detail below. In some embodiments, the transmission power estimation engine 512 may be configured to determine the instantaneous transmission power based on transmission powers associated with a packet. In various embodiments, the transmission power estimation engine 512 may be configured to retrieve, detect, identify, or otherwise determine transmission parameters associated with respective packets. For example, the transmission power estimation engine 512 may be configured determine the transmission parameters from a buffer or queue of the first device 502(1). The transmission parameters may be or include, for instance, a modulation type or modulation and coding scheme (MCS), a packet priority, data rate which is to be used for transmission, payload size, and so forth. The transmission power estimation engine 512 may be configured to determine the instantaneous transmission power of a packet, according to the transmission parameters which correspond to the packet.

In some embodiments, the transmission power estimation engine 512 may be configured to determine the instantaneous transmission power based on channel conditions or metrics associated with the NB communication link 502. In various implementations, the transmission power estimation engine 512 may be configured to measure, assess, or otherwise determine channel conditions for use in determining the instantaneous transmission power. For example, such channel conditions may be or include a received signal strength indicator (RSSI), signal-to-interference-plus-noise (SINR) ratio, path loss, or other characteristics of the NB communication link 502. The transmission power estimation engine 512 may be configured to determine the channel conditions using, based on, or according to signals detected via the transceiver 504. The transmission power estimation engine 512 may be configured to determine the instantaneous transmission power for a particular packet based on the channel conditions. For example, the transmission power estimation engine 512 may be configured to determine the instantaneous transmission power by applying the channel conditions to a model which outputs a corresponding instantaneous transmission power, a look-up table which includes channel condition(s) and corresponding transmission power(s), and so forth.

The first device 402(1) may include an environment detection engine 514. The environment detection engine 514 may be configured to detect, identify, measure, quantify, or otherwise characterize other devices (e.g., one or more third device(s) 518) operating in an environment (such as environment 400) of the first device 402(1) and second device 402(2). In some embodiments, the first device 402(1) may be configured to identify one or more third devices 518 within the environment 400, based on or according to wireless signals associated with the third device(s) 518 operating in frequency bands shared with the NB communication link 502. In various embodiments, such third devices 518 may be or include devices using, operating on, or communicating according to WLAN protocols (e.g., Wi-Fi devices, such as an access point (AP) or station (STA) devices) or other narrowband (NB) protocols (e.g., BLUETOOTH devices). The environment detection engine 514 may be configured to receive wireless signals associated with the third device(s) 518, to assess interference conditions, coexistence considerations, or channel-sharing conditions relevant to transmissions by the first NB device 402(1). The environment detection engine 514 may be configured to measure, detect, or otherwise determine environmental metrics based on such signals relating to the third device(s) 518, such as but not limited to received signal strength indicator (RSSI), a spectral occupancy or channel utilization rate, signal-to-interference-plus-noise ratio (SINR), or other channel conditions.

In various embodiments, the environment detection engine 514 may be configured to receive, detect, or otherwise obtain beacon frames, broadcast transmissions, or advertising signals 520 from the third device(s) 518. For example, the environment detection engine 514 may be configured to detect one or more advertising signals 520 transmitted by WLAN or other devices operating in the shared frequency band. The environment detection engine 514 may be configured to parse or otherwise process such advertising signals 520 to determine the presence of third device(s) 518, identity of the third device(s) 518, capabilities of the third device(s) 518, operating frequency band or range used by the third device(s) 518, or other transmission characteristics of third device(s) 518 within the environment (e.g., environment 400) shared with the first device 402(1). The environment detection engine 514 may be configured to use the information included in the advertising signal(s) 520, to distinguish between conditions that allow simultaneous transmission (e.g., favorable signal-to-interference-plus-noise ratio (SINR) greater than a defined threshold, such as greater than 4 dB), and conditions likely to cause destructive interference, in which coexistence or simultaneous transmission would degrade the communication quality of neighboring devices.

In various implementations, environment detection engine 514 may use received advertising signals 520 (e.g., beacon frames) or direct measurements via the transceiver 504, to determine the presence of third device(s) 518 operating on corresponding WLAN/NB communication links. For example, the environment detection engine 514 may determine whether one or more WLAN devices are actively transmitting in the frequency band to be used by the first device 402(1), or whether one or more other NB devices are actively transmitting in the frequency band to be used by the first device 402(1). The environment detection engine 514 may be configured to characterize measured third-party device signals (frequency, amplitude, spectral density, and duration) for use in adjusting, determining, configuring, or otherwise identifying an EDT to be used for transmitting the packet(s) to the second device 402(2) on the NB communication link 502, as described in greater detail below.

The first device 402(1) may include an EDT determination engine 516. The EDT determination engine 516 may be configured to determine, compute, or otherwise establish an energy detection threshold (EDT). The EDT may be or include a value, threshold, or other limit which governs whether and/or how the first device 402(1) transmits particular packets via the NB communication link 502. The EDT determination engine 516 may be configured to determine the EDT as a function of the instantaneous transmission power (determined by the transmission power estimation engine 512 described above) and a defined value. The defined value may be or include a value, level, metric, threshold, parameter, or other numerical quantity that is determined, obtained, or selected by the first device 402(1), which is used by the first device 402(1) to determine the EDT. In some embodiments, the defined value may be configured or correspond to a defined threshold, limit, or value for transmissions within a particular frequency band (e.g., UNII-1, UNII-3, UNII-5) associated with the NB communication link 502. In various embodiments, the defined value may be configured or correspond to environmental conditions, including the presence or absence of third devices 518 and/or types of third devices 518 (e.g., WLAN and/or NB devices) in the environment of the first device 402(1). In some embodiments, the defined value may be configured or correspond to environment interference conditions, presence or absence of WLAN signals, and/or coexistence involving other NB devices, WLAN devices, or devices operating in other wireless communication protocols.

In some embodiments, the EDT determination engine 516 may be configured to access, retrieve, select, or otherwise determine this defined value based on or according to a frequency band of operation of the NB communication link 502, according to environmental characteristics (e.g., determined by the environment detection engine 514), and/or based on the detected presence of third-party devices 518 (e.g., WLAN devices) identified by environment detection engine 514. For example, the EDT determination engine 516 may be configured to determine the defined value to be higher or lower, depending on whether the first device 502(1) is transmitting in an environment which includes other WLAN or narrowband devices, according to detected environmental conditions, as determined by the environment detection engine 514, and so forth.

In various embodiments, the EDT determination engine 516 may be configured to configure, compute, identify, or otherwise determine the EDT based on a defined or configured relationship between the defined value and the instantaneous transmission power for a packet. For example, and according to various embodiments described above, the EDT determination engine 516 may be configured to determine the EDT by subtracting or reducing the defined value by the instantaneous transmission power for a particular packet. For instance, assuming that (according to a frequency band of operation of the NB communication link 502, the environmental characteristics, and/or based on the detected presence of third-party devices 518) the defined value is −74 dBm, and assuming that the instantaneous transmission power determined by the transmission power estimation engine 512 is 5 dBm, the EDT determination engine 516 may be configured to determine the EDT by subtracting the instantaneous transmission power (e.g., 5 dBm) from the defined value (e.g., −74 dBm), or −79 dBm. Similarly, if the defined value is −74 dBm and, assuming that the instantaneous transmission power determined by the transmission power estimation engine 512 is −2 dBm, the EDT determination engine 516 may be configured to determine the EDT by subtracting the instantaneous transmission power (e.g., −2 dBm) from the defined value (e.g., −74 dBm), or −72 dBm.

In certain implementations, the EDT determination engine 516 may further be configured to dynamically adjust, configure, or otherwise modify the packet transmission conditions (e.g., the transmission power for transmitting the packet) based on or according to measured reception (RX) energy detected on the NB communication link 502. In some embodiments, the EDT determination engine 516 may be configured to modify the transmission power according to the measured RX energy, based on a count of retry attempts for transmitting the packet. For instance, when measured RX energy is determined by the EDT determination engine 516 to be greater than the current EDT threshold, and when the count of retry attempts meets or exceeds a threshold value (e.g., corresponding to a last or final retry attempt), the EDT determination engine 516 may be configured to reduce the instantaneous transmission power to facilitate transmission of the packet. For example, where the count of retry attempts satisfies the threshold value, the EDT determination engine 516 may be configured to reduce the instantaneous transmission power for transmitting the packet according to a difference between the measured RX energy and the configured/defined/determined EDT value. In this example, the EDT determination engine 516 may be configured to reduce the instantaneous transmission power based on the measured RX energy and the EDT value. Because the EDT determination engine 516 determines the EDT based on the instantaneous transmission power, the reduction in instantaneous transmission power may correspondingly result in a reduced EDT value, thereby permitting transmission of the packet at the reduced power level. In some embodiments, as opposed to reducing the instantaneous transmission power where the count of retry attempts satisfies the threshold value, the EDT determination engine 516 may be configured to increase the instantaneous transmission power and transmit the packet (e.g., at a maximum or planned power level), irrespective of the measured RX energy. For instance, the EDT determination engine 516 may be configured to increase the transmission power for a packet which is on a last retry attempt and is a high-priority packet. In such instances, the transmission of the packet may cause interference, but is otherwise being transmitted as opposed to being dropped (which may not be optimal for high-priority packet(s)).

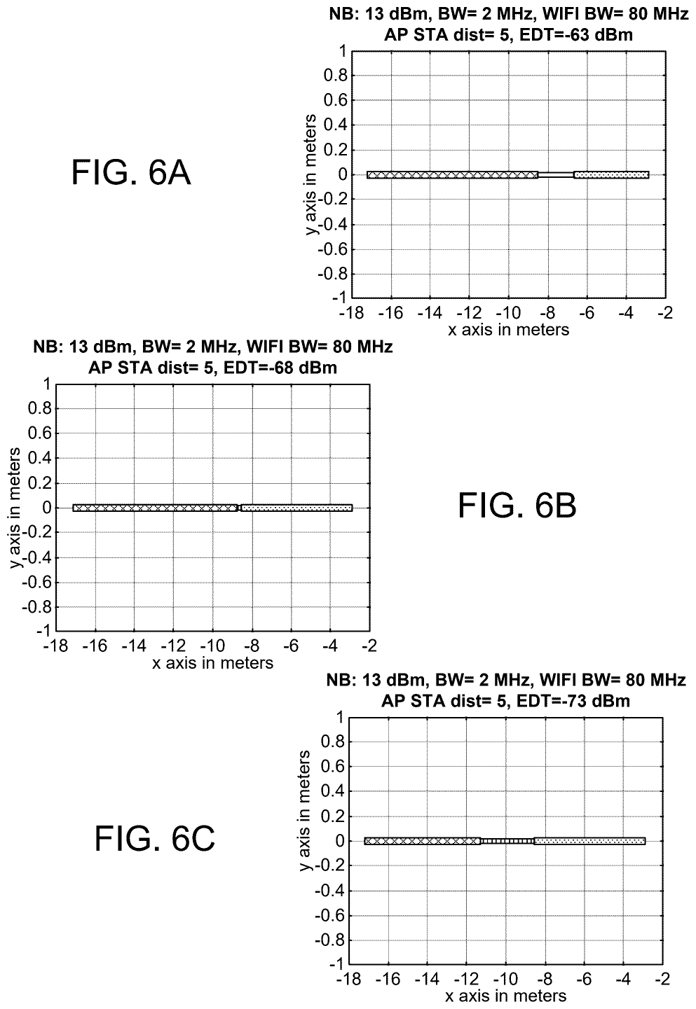

Referring now to FIG. 6A through FIG. 14C, depicted are simulations relating to various operating scenarios involving narrowband (NB) and WLAN devices sharing common frequency bands, and the corresponding impacts of these scenarios upon optimal EDT values. In these simulations, several operating parameters and conditions were varied, including separation between communicating devices (distance D1 of FIG. 4), instantaneous transmission powers of the NB device, bandwidths of the WLAN transmissions, and specific frequency bands used (such as UNII-1, UNII-3, and UNII-5 bands). In these figures, different pattern fills denotes different outcomes based on the simulations. In particular, a pattern fill with dot hatching denotes successful non-transmission (e.g., where a NB device does not and should not transmit a signal which would cause interference), a pattern fill with cross hatching denotes successful transmission (e.g., where a NB device transmits a signal which does not cause interference), a pattern fill with vertical hatching denotes a lost opportunity (e.g., where a NB device does not transmit a signal but could have), and a pattern fill with horizontal hatching denotes an interference transmission (e.g., where a Nb device transmits a signal which causes interference).

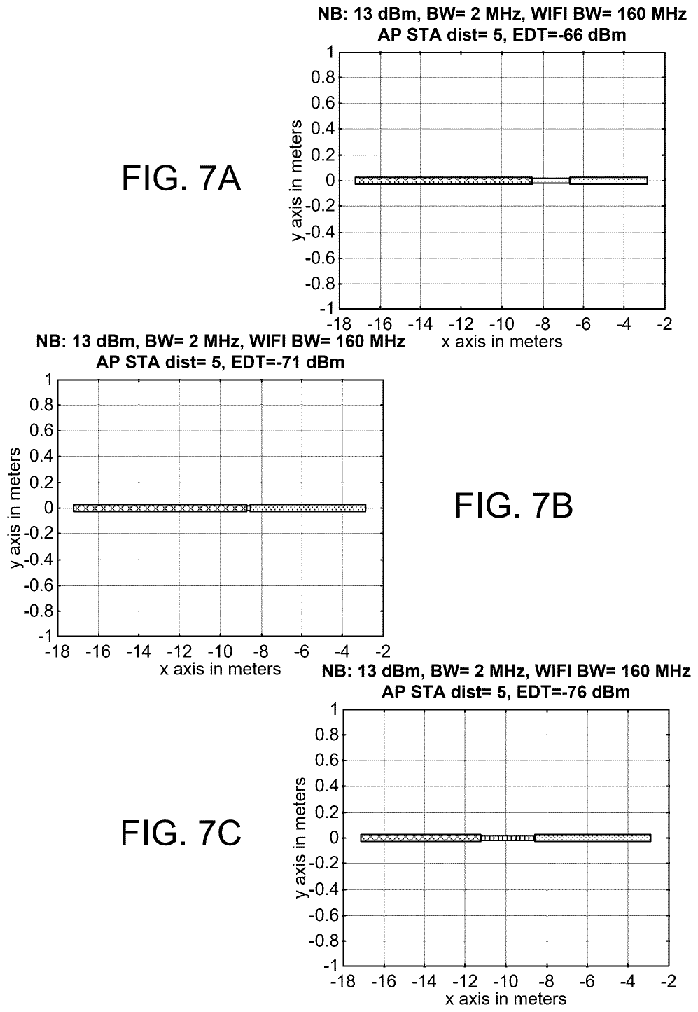

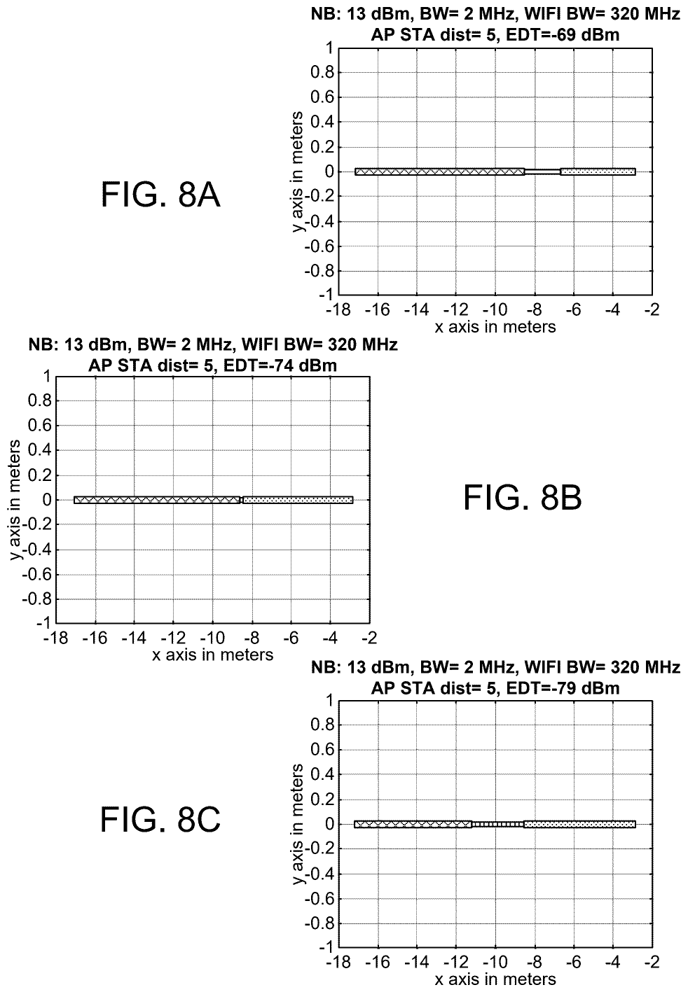

In the scenarios illustrated by FIG. 6A through FIG. 8C, WLAN device bandwidths are progressively varied among 80 MHz, 160 MHz, and 320 MHz, respectively, while the NB device transmission power remains fixed at approximately 13 dBm, and the distance D1 between WLAN devices (e.g., between the first WLAN device 404(1) and second WLAN device 404(2)) is fixed at approximately 5 meters. In FIG. 6A-C, corresponding to a WLAN bandwidth of 80 MHz, simulations illustrate that selecting an overly permissive EDT at −63 dBm (in FIG. 6A) can increase NB-to-WLAN interference. Conversely, selecting too restrictive an EDT at −73 dBm (in FIG. 6C) reduces harmful interference but also results in unnecessary lost NB transmission opportunities. Under these operating conditions, an EDT value of −68 dBm (as shown in FIG. 6B) represents an optimal or near-optimal compromise, balancing interference minimization with preservation of effective NB device transmission capability. Similar trends appear in FIG. 7A-C (160 MHz WLAN bandwidth), where an EDT of −66 dBm results in increased interference, −76dBm results in lost transmission opportunities, and an EDT of approximately −71 dBm may be optimal for 160 MHz bandwidth operating conditions. In FIG. 8A-C, with a 320 MHz WLAN bandwidth, an EDT of −69 dBm has similarly increased interference, −79 dBm results in loss of NB transmission opportunities, and an EDT of around −74 dBm may provide an optimal for such operating conditions.

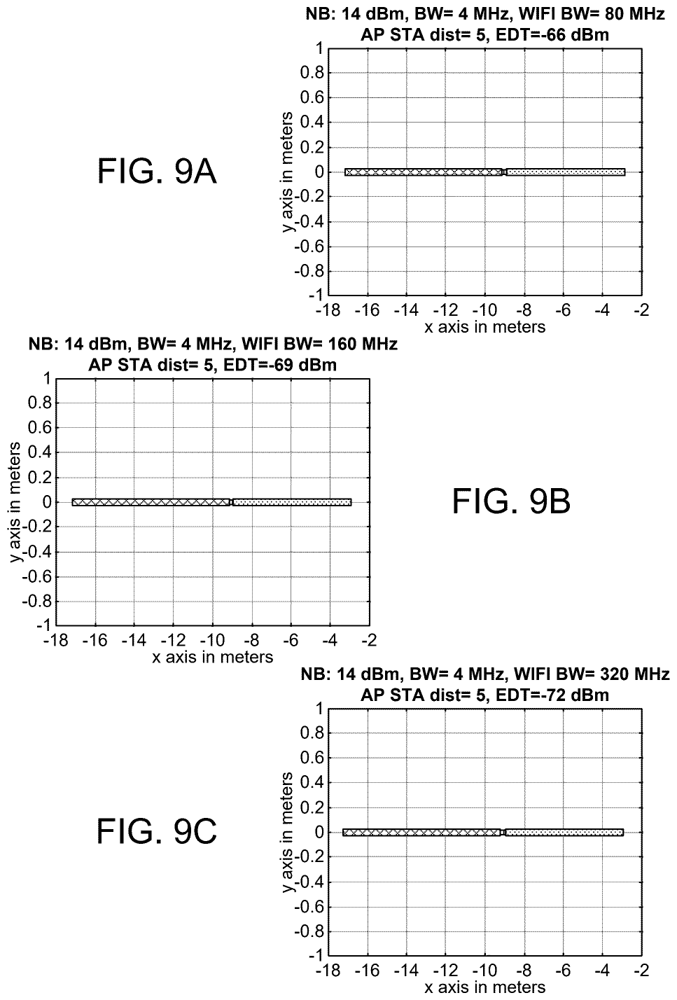

FIG. 9A-FIG. 9C depict additional operating scenarios involving variations in WLAN bandwidth at fixed conditions of a NB device power of approximately 14 dBm, a NB bandwidth of 4 MHz, and a fixed device distance (D1) of approximately 5 meters. In these examples, simulations show how, for higher WLAN transmission bandwidths, optimal EDT values gradually shift to more restrictive (lower) values, such as optimal EDT values of −72 dBm, −75 dBm, and −78 dBm corresponding to WLAN bandwidths of 80 MHz, 160 MHz, and 320 MHz, respectively. While each incremental increase in WLAN bandwidth may correspondingly result in changes to EDT thresholds for optimized coexistence, these optimal EDT values may represent an appropriate balance between avoiding interference and efficiently using available NB transmission opportunities (similar to what is shown in the contrast between FIG. 6B, FIG. 7B, and FIG. 8B, as compared to FIGS. 6A and 6C, FIGS. 7A and 7C, and FIGS. 8A and 8C, respectively).

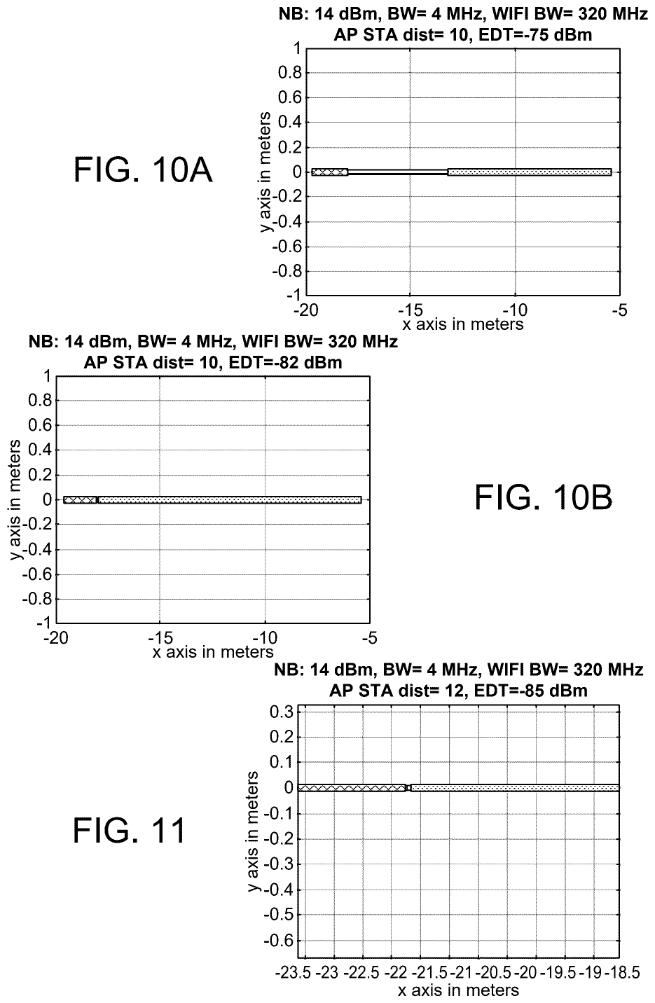

FIG. 10A-B and FIG. 11 illustrate scenarios modeled in environment 400 with a WLAN bandwidth of 320 MHz, the distance D1 between WLAN devices 404 are increased to assess its effect on optimal EDT selection. In FIG. 10A-B, D1 is increased to approximately 10 meters (with NB power at approximately 14 dBm and NB bandwidth of 4 MHz), resulting in an optimal EDT value around −82 dBm. Similarly, as distance D1 increases further to approximately 12 meters in FIG. 11, the corresponding optimal EDT value further decreases (becomes more restrictive), with approximately at −85 dBm being an optimized EDT value. In these simulated scenarios, increasing separation distance may result in increased sensitivity (lower EDT values) to maximize coexistence efficiency and reduce interference effects under more spatially separated positioning.

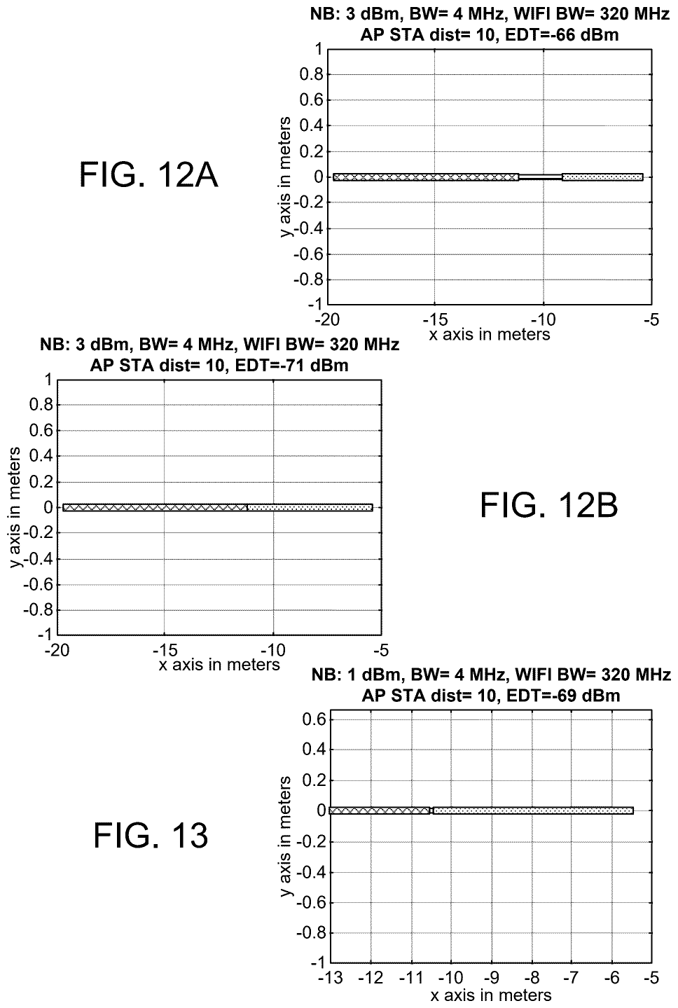

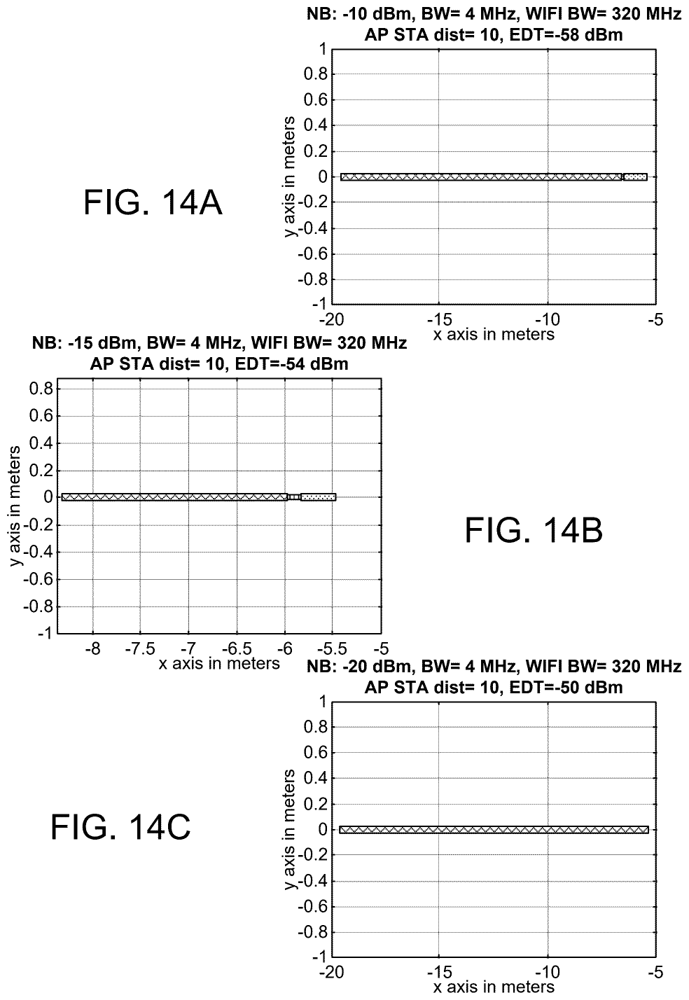

Simulations in FIG. 12A-B, FIG. 13, and FIG. 14A-C illustrate the impact of reducing the NB instantaneous transmission power at fixed WLAN bandwidth (320 MHz) and fixed D1 distance (approximately 10 meters). Specifically, FIG. 12A-B depict an operating scenario in which the NB instantaneous power is approximately 3 dBm, resulting in an optimal EDT of approximately −71 dBm. In contrast, FIG. 13 illustrates a scenario under similar circumstances, but with NB instantaneous power further reduced to approximately 1 dBm, resulting in an optimal EDT of approximately −69 dBm. Continuing in FIG. 14A-C, simulations illustrate NB power further reduced to values of approximately −10 dBm, −15 dBm, and −20 dBm respectively, demonstrating corresponding optimal EDT values progressively increasing to approximately −58 dBm, −54 dBm, and −50 dBm. In other words, as instantaneous NB power is reduced, optimal EDT values become less restrictive because interference impacts on nearby WLAN devices correspondingly diminish.

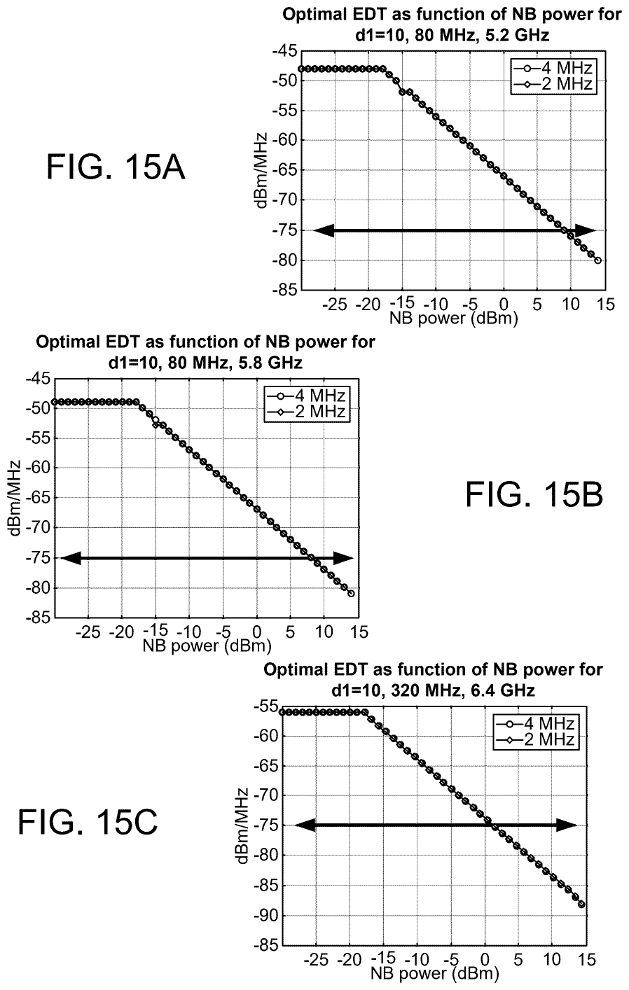

Referring now to FIG. 15A-15C, depicted are graphs showing optimized EDTs for devices operating with a maximum transmission power less than 14 dBm. In each of these examples, the WLAN devices may be separated by a distance D1 of 10 m, and EDTs are shown for devices (e.g., narrowband devices) operating in 2 or 4 megahertz (MHz). In FIG. 15A, the devices may be communicating in a 5.2 gigahertz (GHz) frequency spectrum (e.g., UNII-1) with WLAN devices communicating on an 80 MHz channel. In FIG. 15B, the devices may be communicating in a 5.8 GHz spectrum (e.g., UNII-3/4) with WLAN devices communicating on an 80 MHz channel. In FIG. 15C, the devices may be communicating in a 6.4 GHz frequency spectrum (e.g., UNII-5) with WLAN devices communicating on a 320 MHz channel.

With continued reference to FIG. 5, the EDT determination engine 516 may be configured to determine the EDT as a function of a defined value and the transmission power (e.g., determined by the TX power estimation engine 512). The defined value may be equal to an EDT value at a transmission power of 0 dBm. The EDT determination engine 516 may be configured to determine the defined value based on or according to operating conditions/environment conditions, and so forth. For example, the EDT determination engine 516 may be configured to determine the defined value based on the frequency band in which the devices 402 are to communicate (e.g., UNII-1, UNII-3/4, UNII-5). As another example, the EDT determination engine 516 may be configured to determine the defined value based on a distance between WLAN devices 404 (e.g., d1), which may be reported by the WLAN devices 404, determined based on sensor measurements, and so forth. As still another example, the EDT determination engine 516 may be configured to determine the defined value based on the frequency channel bandwidth used by neighboring devices (e.g., WLAN devices 404). In some embodiments, the EDT determination engine 516 may be configured to determine the defined value by performing a look-up in a table using the metrics/conditions determined by the environment detection engine 514, to determine the corresponding defined value.

In the example shown in FIG. 15A, the EDT determination engine 516 may be configured to determine the defined value as −66 dBm/MHz. In the example shown in FIG. 15B, the EDT determination engine 516 may be configured to determine the defined value as −67 dBm/MHz. In the example shown in FIG. 15C, the EDT determination engine 516 may be configured to determine the defined value as −74 dBm/MHz. These defined values are merely illustrative based on particular operating conditions. It should be noted that additional or alternative defined values may be used based on operating conditions, environment metrics, and so forth.

The EDT determination engine 516 may be configured to determine the EDT based on, according to, or as a function of the defined value and the transmission power (e.g., determined by the TX power estimation engine 512). In some embodiments, the EDT determination engine 516 may be configured to determine the EDT by reducing the defined value by the transmission power determined by the TX power estimation engine 512 (e.g., EDT=defined value−TX). In this regard, the EDT may be reduced for higher transmission powers (e.g., a more stringent EDT) that approach 14 dBm. As the transmission power reduces, the EDT may correspondingly increase (e.g., to be a less stringent EDT). In some embodiments, the EDT may be fixed at a transmission power which is less than a predetermined transmission power (e.g., −18 dBm). For example, the EDT may linearly increase as the transmission power decreases between 14 dBm and the predetermined transmission power (e.g., −18 dBm). Where the transmission power is less than, or less than or equal to the predetermined transmission power, the EDT determination engine 516 may determine a fixed EDT value (e.g., −48 dBm/MHz in FIG. 15A, −49 dBm/MHz in FIG. 15B, and −56 dBm/MHz in FIG. 15C). While this example is described, the fixed EDT value may be any value (e.g., up to an infinite EDT), as the transmission power being less than (or less than or equal to) the predetermined transmission power may have a low likelihood of causing interference to any nearby/neighboring devices where a packet is transmitted with the low transmission power.

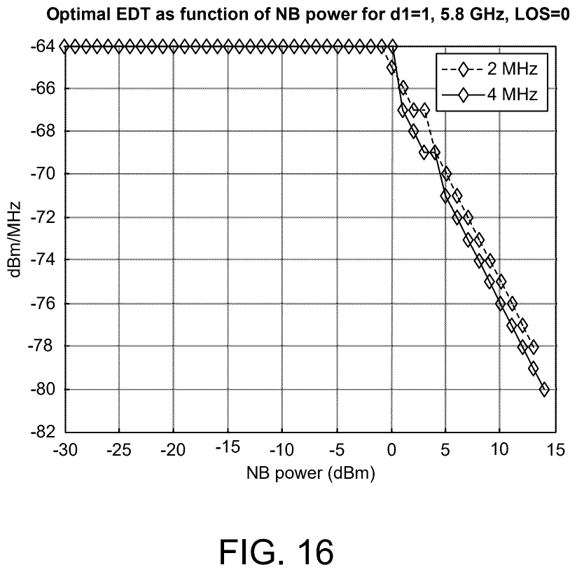

Referring now to FIG. 16, depicted is a graph showing optimized EDTs for devices (e.g., 2 megahertz MHz or 4 MHz narrowband devices) operating with a maximum transmission power less than 14 dBm. In FIG. 16, the optimized EDT may be using a distance between WLAN devices (e.g., D1) of 1 m, and operating in 5.8 GHz frequency band. As shown in FIG. 16, the EDT may increase linearly for maximum transmission powers between 14 dBm to approximately 0 dBm, while maintain at a relatively flat/constant value (e.g., −64 dBm/MHz) for maximum transmission powers which are less than 0 dBm.

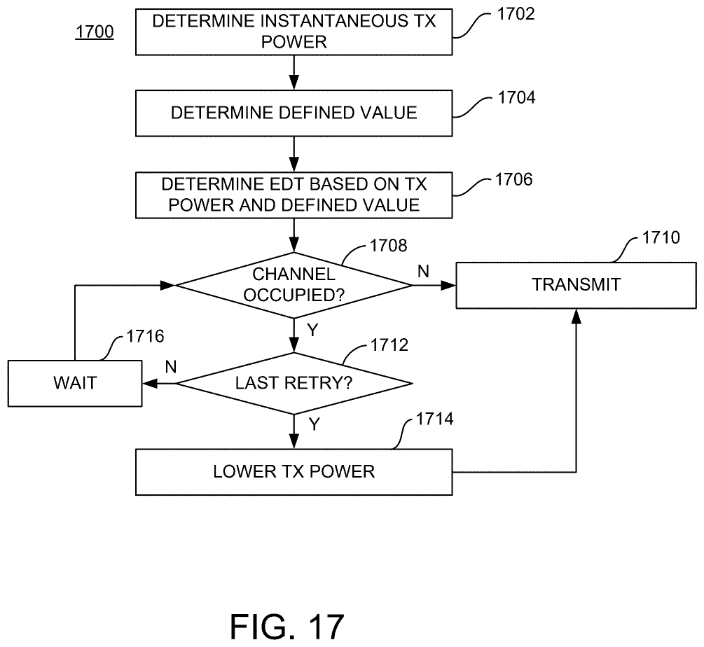

Referring now to FIG. 17, depicted is a flowchart showing an example method 1700 of configuring an energy detection threshold, according to an example implementation of the present disclosure. The method 1700 may be performed, implemented, or otherwise executed by the devices, components, elements, or hardware described above with reference to FIG. 1-FIG. 16. As a brief overview, at step 1702, a device may determine an instantaneous transmission (TX) power. At step 1704, the device may determine a defined value. At step 1706, the device may determine an energy detection threshold (EDT) based on the instantaneous TX power or maximum TX power and the defined value. At step 1708, the device may determine whether a channel is occupied. At step 1710, the device may transmit a packet. At step 1712, the device may determine whether an attempt to transmit the packet is a last retry. At step 1714, the device may lower the instantaneous transmission power. At step 1716, the device may wait a duration to reattempt transmission.

At step 1702, a device may determine an instantaneous transmission (TX) power. In some embodiments, the device may determine the instantaneous TX power for a packet to be transmitted by the device (e.g., a first device) to another device (e.g., a second device) via a narrowband (NB) communication link. In some embodiments, the device may determine the instantaneous TX power based on packet-specific transmission parameters (e.g., a packet modulation scheme, data payload size, a data priority, and so forth). Additionally or alternatively, the device may determine the instantaneous transmission power based on measured channel metrics or conditions (e.g., RSSI, SINR, or path loss metrics measured over the NB communication link). In some embodiments, the device may determine the instantaneous TX power by inputting the measured channel metrics/transmission parameters into a lookup table or model (e.g., stored in memory) which includes the metrics/TX parameters and corresponding instantaneous TX power which to be used for transmitting the corresponding packet.

At step 1704, the device may determine a defined value. In some embodiments, the device may determine the defined value for use in determining the energy detection threshold. The device may determine the defined value based on or according to one or more environmental metrics or conditions (e.g., relating to the NB communication link and/or other devices communicating in an environment of the first and second devices). The device may determine the defined value by performing a look-up using the environmental metrics/conditions to identify, retrieve, or otherwise determine the corresponding defined value. For example, the device may perform a look-up operation that which maps a received signal strength indicator (RSSI) measured by the device of neighboring devices, frequency bands or channels which are used by the device and/or neighboring devices, and/or indications of WLAN presence from neighboring devices (and/or communication metrics, such as bandwidth, frequency bands, etc. used by neighboring devices), to a predetermined numerical defined value. The lookup mapping may include, for example, a predefined set of numerical thresholds stored in a data structure in memory that includes a correspondence between defined values and environment metrics.

In some embodiments, the device may determine the defined value to be used to determine the EDT, based at least on a frequency band corresponding to the NB communication link. For example, the device may determine a frequency band identifier (e.g., UNII-1, UNII-3, UNII-5, etc.) from parameters associated with configuration of the NB communication link. The device may use the frequency band identifier to perform a table look-up within memory of the device, to retrieve a corresponding defined value specific to the corresponding frequency band.

In some embodiments, the device may determine the defined value to be used to determine the EDT, based at least on a presence of one or more third devices in an environment, including the first device and the second device, which operate on a wireless local area network (WLAN) communication link in the environment. In some embodiments, the device may determine the presence of the third device(s) based on an advertising signal indicating the presence of the one or more third devices operating on the WLAN communication link. The advertising signal may originate from (e.g., as a broadcast message or signal, a targeted unicast advertising signal, etc.) an access point of the third device(s). For instance, the device may periodically or continuously monitor wireless signals in the environment, detect WLAN advertising signals broadcast by WLAN access points, and parse or analyze such signals to extract parameters indicating WLAN device presence, identity, and/or operational bandwidth. The device may determine the defined value based on the parameters broadcast or otherwise signaled by neighboring device(s) (e.g., in the advertising signal(s)).

In some embodiments, the defined value is a numerical value within a range between −65decibels relative to one milliwatt per megahertz dBm/MHz and −85 dBm/MHz. The device may select a numerical value within the rage based on configured or predefined communication settings, real-time detected interference conditions or metrics, and/or device-specific configuration parameters, such as distance between devices or operating frequency band characteristics.

At step 1706, the device may determine an energy detection threshold (EDT) based on the instantaneous TX power and the defined value. In some embodiments, the device may determine the EDT as a function of the instantaneous TX power for the packet and a defined value. In some embodiments, the device may determine the EDT as a function of the instantaneous TX power and the defined value by reducing the defined value by the instantaneous TX power.

In some embodiments, the device may determine that a maximum transmission power is less than (or less than or equal to) a threshold transmission power. The threshold transmission power may be, for example, 14 dBm, though other maximum transmission powers may be used according to various implementations of the present disclosure. The device may determine the EDT as a function of the instantaneous transmission power and the defined value responsive to the maximum transmission power being less than (or less than or equal to) the threshold transmission power. For example, responsive to determining that the maximum configured transmission power of the NB device is less than (or less than or equal to) a defined threshold (e.g., 14 dBm), the device may automatically implement the function-based EDT calculation (defined value reduced by instantaneous TX power).

In some embodiments, the device may determine whether the instantaneous transmission power is less than (or less than or equal to) a threshold transmission power. The threshold transmission power may be below 0 dBm. For example, the threshold transmission power may be −18 dBm. Where the instantaneous TX power is less than (or less than or equal to) the threshold transmission power, the device may determine the EDT as a defined EDT value. The defined EDT value may be dependent on the environmental conditions/metrics (similar to determining the defined value used for determining the EDT value described above). For instance, the device may access memory storing a predefined EDT floor value that is selected based on identifying environmental conditions (such as distinct frequency band or WLAN presence). If, for instance, the device determines (at step 1702) an instantaneous TX power which is less than a threshold TX power (e.g., −18 dBm), the device may select the predefined EDT floor irrespective of further decreases in transmission power.

At step 1708, the device may determine whether a channel is occupied. In some embodiments, the device may determine whether a channel is occupied, based on a reception (RX) energy of signal(s) received on the NB channel. The device may determine whether a channel is occupied based on a comparison of the RX energy of the signal(s) to the EDT. For example, the device may measure RX energy via circuitry in the transceiver over a defined listening or sensing interval. The device may compare the measured RX energy (e.g., numerically or algorithmically) against the EDT threshold determined at step 1706, to determine a channel occupancy status. The device may determine that the channel is occupied responsive to the RX energy being greater than, or greater than or equal to, the EDT. The device may determine that the channel is not occupied responsive to the RX energy being less than, or less than or equal to, the EDT. Where the device determines that the channel is not occupied, the method 1700 may proceed to step 1710. Where the device determines that the channel is occupied, the method 1700 may proceed to step 1712.

At step 1710, the device may transmit the packet. In some embodiments, the device may transmit the packet to the second device. The device may transmit the packet to the second device according to the EDT via the NB communication link. The device may transmit the packet using the instantaneous TX power.

At step 1712, the device may determine whether an attempt to transmit the packet is a last retry. In some embodiments, the device may determine whether the attempt to transmit the packet is a last retry attempt. The device may determine whether the attempt is a last retry attempt, based on a count of attempts to transmit the packet. Where the count of attempts satisfies a threshold count (which may depend on traffic type, priority, etc.), the device may determine that the attempt is a last retry attempt. Where, at step 1712, the device determines that the attempt is a last retry attempt, the method may proceed to step 1714. Where the device determines that the attempt is not a last retry attempt, the method may proceed to step 1716.

At step 1714, the device may lower the instantaneous transmission power. In some embodiments, the device may lower (or reduce) the instantaneous TX power for the packet to be transmitted to the second device, based on the RX energy being greater than the EDT threshold (e.g., indicating the channel is occupied). The device may reduce the instantaneous TX power responsive to determining that the attempt is a last retry attempt. In some embodiments, the device may reduce the instantaneous TX power based on a difference between the RX energy and the EDT threshold. For instance, the device may reduce the instantaneous TX power by the difference between the RX energy and the EDT threshold. By reducing the instantaneous TX power by the difference, the EDT threshold will correspondingly change (e.g., because the EDT is a function of the instantaneous TX power), such that the RX energy would be equal to (or less than or equal to) the EDT threshold. Accordingly, by reducing the instantaneous transmission power by the difference such that the EDT threshold no longer indicates that the channel is occupied according to the RX energy, the method 1700 may proceed to step 1710 where the device transmits the packet.

In some embodiments, as opposed to reducing the instantaneous transmission power at step 1714, in some implementations and instances (such as for high priority traffic), the device may increase the instantaneous transmission power and transmit the packet (e.g., at a maximum or planned power level), irrespective of the measured RX energy. For instance, the device may increase the transmission power for a packet which is on a last retry attempt and is a high-priority packet (e.g., a packet having latency sensitive traffic, may become stale, and so forth). By increasing the transmission power for high priority packets (and in other scenarios), the packet may be transmitted with the higher transmission power to the receiving device. In some instances, the transmission of the packet at the higher (e.g., increased) transmission power may cause interference with neighboring devices, but is otherwise transmitted as opposed to being dropped.

At step 1716, the device may wait a duration to reattempt transmission. In some embodiments, the device may wait a number of slots or scheduled time periods in which to reattempt transmission. The device may increase a counter used to determine whether attempts are last retry attempts at step 1716. Following waiting the duration, the method 1700 may proceed back to step 1708, where the device re-checks for RX energy to determine whether the channel is occupied.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
determining, by a first device, an instantaneous transmission power for a packet to be transmitted by the first device to a second device via a narrowband (NB) communication link;
determining, by the first device, an energy detection threshold (EDT), as a function of the instantaneous transmission power for the packet and a defined value; and
transmitting, by the first device to the second device, the packet according to the EDT via the NB communication link.

2. The method of claim 1, wherein determining the EDT as a function of the instantaneous transmission power and the defined value comprises determining the EDT by reducing the defined value by the instantaneous transmission power.

3. The method of claim 1, further comprising determining, by the first device, that a maximum transmission power is less than, or less than or equal to, a threshold transmission power, wherein the first device determines the EDT as a function of the instantaneous transmission power and the defined value responsive to the maximum transmission power being less than, or less than or equal to the threshold transmission power.

4. The method of claim 3, wherein the threshold transmission power is 14 dBm.

5. The method of claim 1, further comprising:
determining, by the first device, the defined value to be used to determine the EDT, based at least on a frequency band corresponding to the NB communication link.

6. The method of claim 1, further comprising:
determining, by the first device, the defined value to be used to determine the EDT, based at least on a presence of one or more third devices which operate on a wireless local area network (WLAN) communication link, the one or more third devices being located in an environment which also includes the first device and the second device.

7. The method of claim 6, further comprising:
receiving, by the first device, an advertising signal indicating the presence of the one or more third devices operating on the WLAN communication link.

8. The method of claim 1, wherein the defined value is a numerical value within a range between −65 decibels relative to one milliwatt per megahertz (dBm/MHz) and −85 dBm/MHz.

9. The method of claim 1, further comprising:
detecting, by the first device, a reception (RX) energy on the NB communication link which is greater than the EDT threshold;
reducing, by the first device, the instantaneous transmission power for the packet to be transmitted to the second device, based on the RX energy being greater than the EDT threshold; and
transmitting, by the first device, the packet according to the EDT based on the reduction of the instantaneous transmission power.

10. The method of claim 9, further comprising:
determining, by the first device, that an attempt to transmit the packet is a last retry attempt,
wherein reducing the instantaneous transmission power for the packet is performed based on the attempt being the last retry attempt.

11. A first device, comprising:
a wireless transceiver configured to operate on narrowband (NB) communication links; and
one or more processors configured to:
determine an instantaneous transmission power for a packet to be transmitted by the first device to a second device via a narrowband (NB) communication link;
determine an energy detection threshold (EDT), as a function of the instantaneous transmission power for the packet and a defined value; and
transmit, via the wireless transceiver to the second device, the packet according to the EDT via the NB communication link.

12. The first device of claim 11, wherein the one or more processors are configured to determine the EDT by reducing the defined value by the instantaneous transmission power.

13. The first device of claim 11, wherein the one or more processors are configured to determine that a maximum transmission power is less than, or less than or equal to, a threshold transmission power of 14 dBm, and determine the EDT as a function of the instantaneous transmission power and the defined value responsive to the maximum transmission power being less than, or less than or equal to the threshold transmission power.

14. The first device of claim 11, wherein the one or more processors are configured to:
determine the defined value to be used to determine the EDT, based at least on a frequency band corresponding to the NB communication link.

15. The first device of claim 11, wherein the one or more processors are configured to:
determine the defined value to be used to determine the EDT, based at least on a presence of one or more third devices which operate on a wireless local area network (WLAN) communication link, the one or more third devices being located in an environment which also includes the first device and the second device.

16. The first device of claim 15, wherein the one or more processors are configured to:
receive, via the wireless transceiver, an advertising signal indicating the presence of the one or more third devices operating on the WLAN communication link.

17. The first device of claim 11, wherein the defined value is a numerical value within a range between−65 decibels relative to one milliwatt per megahertz (dBm/MHz) and −85 dBm/MHz.

18. The first device of claim 11, wherein the one or more processors are configured to:
detect a reception (RX) energy on the NB communication link which is greater than the EDT threshold;
reduce the instantaneous transmission power for the packet to be transmitted to the second device, based on the RX energy being greater than the EDT threshold; and
transmit, via the wireless transceiver, the packet according to the EDT based on the reduction of the instantaneous transmission power.

19. The first device of claim 18, wherein the one or more processors are configured to:
determine that an attempt to transmit the packet is a last retry attempt, and
reduce the instantaneous transmission power for the packet based on the attempt being the last retry attempt.

20. A non-transitory computer readable medium storing instructions that, when executed by one or more processors of a first device, cause the one or more processors to:
determine an instantaneous transmission power for a packet to be transmitted by the first device to a second device via a narrowband (NB) communication link;
determine an energy detection threshold (EDT), as a function of the instantaneous transmission power for the packet and a defined value; and
transmit, via a transmitter to the second device, the packet according to the EDT via the NB communication link.
